(19) United States
(12) Patent Application Publication
(10) Pub. No.: US 2025/0095212 A1
(43) Pub. Date: Mar. 20, 2025

(54) METHOD FOR TRANSMITTING AND OBTAINING DYNAMIC 3-DIMENSIONAL AVATAR DATA AND APPARATUS FOR THE SAME

(71) Applicant: ELECTRONICS AND TELECOMMUNICATIONS RESEARCH INSTITUTE, Daejeon (KR)

(72) Inventors: Da Yun NAM, Daejeon (KR); Seong Yong LIM, Daejeon (KR); Hyuk Min KWON, Daejeon (KR); Hyun Cheol KIM, Daejeon (KR); Joo Myoung SEOK, Daejeon (KR)

(21) Appl. No.: 18/883,222

(22) Filed: Sep. 12, 2024

(30) Foreign Application Priority Data
Sep. 15, 2023 (KR) 10-2023-0123381
Aug. 21, 2024 (KR) 10-2024-0111837

(51) Int. Cl. G06T 9/00

(52) U.S. Cl. CPC G06T 9/001

(57) ABSTRACT

A method and a device for transmitting and obtaining dynamic 3-dimensional (3D) avatar data are provided. The method for transmitting dynamic 3D avatar data may include generating a plurality of data elements configuring the dynamic 3D avatar data; performing first encoding and transmission for a first data element of the plurality of data elements; and performing second encoding and transmission for a second data element of the plurality of data elements. Each of at least one of the first data element or the second data element may be divided into a plurality of sub-data elements.

### CROSS-REFERENCE TO RELATED APPLICATIONS

This application claims the benefit of earlier filing date and right of priority to Korean Application No. 10-2023-0123381, filed on Sep. 15, 2023, and Korean Application No. 10-2024-0111837, filed on Aug. 21, 2024, the contents of which are all hereby incorporated by reference herein in their entirety.

### BACKGROUND

### 1. Technical Field

The present disclosure relates to 3-dimensional avatar data, and more specifically, relates to a method for transmitting and obtaining dynamic 3-dimensional avatar data and a device for the same.

### 2. Description of Related Art

According to the market demand for various 3D contents such as a 3D avatar that expresses a character or a person in metaverses, 3D animations, and 3D games, the need for improving the existing technology and developing the technology for compressing and transmitting or receiving high-quality and high-capacity 3D content data is increasing.

Since the existing retargeting method based on 3D motion information transmits or receives only low-capacity motion information and retarget it to a shape and a texture of a predetermined character to synthesize a 3D avatar, there are problems that transmission or reception efficiency is high and computational complexity is low, but discomfort in a 3D avatar is high. Meanwhile, the existing volumetric video compression and transmission method may expect a high-quality 3D avatar without discomfort, but there are problems that it requires high-capacity data transmission or reception and has high computational complexity. A new technology is required to improve this existing method and reproduce high transmission or reception efficiency and a high-quality 3D avatar.

### SUMMARY

The present disclosure is to provide a method and a device for transmitting and obtaining dynamic 3-dimensional avatar data.

The present disclosure is to provide a method for efficiently transmitting high-quality data by configuring dynamic 3-dimensional avatar data with a plurality of data elements and/or sub-data elements and obtaining 3-dimensional avatar data based thereon and a device therefor.

The technical objects to be achieved by the present disclosure are not limited to the above-described technical objects, and other technical objects which are not described herein will be clearly understood by those skilled in the pertinent art from the following description.

A method for transmitting dynamic 3-dimensional (3D) avatar data according to an embodiment of the present disclosure may include generating a plurality of data elements configuring the dynamic 3D avatar data; performing first encoding and transmission for a first data element of the plurality of data elements; and performing second encoding and transmission for a second data element of the plurality of data elements. Each of at least one of the first data element or the second data element may be divided into a plurality of sub-data elements.

A device for transmitting dynamic 3-dimensional (3D) avatar data according to an additional embodiment of the present disclosure may include at least one processor; and at least one memory operably connected to the at least one processor and storing instructions that make the device to perform an operation when executed by the at least one processor. The operation may include generating a plurality of data elements configuring the dynamic 3D avatar data; performing first encoding and transmission for a first data element of the plurality of data elements; and performing second encoding and transmission for a second data element of the plurality of data elements. Each of at least one of the first data element or the second data element may be divided into a plurality of sub-data elements.

In some embodiments of the present disclosure, a period of the first encoding and transmission and a period of the second encoding and transmission may be adaptively determined based on a characteristic of the first data element and the second data element, respectively.

In some embodiments of the present disclosure, when the first data element is divided into a plurality of sub-data elements, the first encoding and transmission for the first data element may include first period-based encoding and transmission for a first sub-data element among the plurality of sub-data elements and second period-based encoding and transmission for a second sub-data element among the plurality of sub-data elements.

In some embodiments of the present disclosure, the first period and the second period may be adaptively determined based on the degree of change in an attribute of the first sub-data element and the second sub-data element over time, respectively.

In some embodiments of the present disclosure, the first data element may be divided into the plurality of sub-data elements by referring to information of the second data element.

In some embodiments of the present disclosure, the encoding and transmission of the plurality of sub-data elements may be performed independently or in parallel.

In some embodiments of the present disclosure, at least one sub-avatar data may be configured based on a combination of the first data element, or at least one sub-data element of the first data element; and the second data element, or at least one sub-data element of the second data element.

In some embodiments of the present disclosure, the first data element may correspond to volumetric data including avatar geometric data and avatar texture data, and the second data element may correspond to avatar skeleton motion data.

In some embodiments of the present disclosure, the plurality of data elements may further include at least one of avatar audio data, avatar haptic data or avatar metadata.

A method for obtaining dynamic 3-dimensional (3D) avatar data according to an additional embodiment of the present disclosure may include obtaining the first data element based on first reception and decoding for an encoded first data element of a plurality of data elements; obtaining the second data element based on second reception and decoding for an encoded second data element of the plurality of data elements; and obtaining the dynamic 3D avatar data based on the plurality of data elements including the first data element and the second data element. Each of at least one of the first data element or the second data element may be divided into a plurality of sub-data elements.

A device for obtaining dynamic 3-dimensional (3D) avatar data according to an additional embodiment of the present disclosure may include at least one processor; and at least one memory operably connected to the at least one processor and storing instructions that make the device to perform an operation when executed by the at least one processor. The operation may include obtaining the first data element based on first reception and decoding for an encoded first data element of a plurality of data elements; obtaining the second data element based on second reception and decoding for an encoded second data element of the plurality of data elements; and obtaining the dynamic 3D avatar data based on the plurality of data elements including the first data element and the second data element. Each of at least one of the first data element or the second data element may be divided into a plurality of sub-data elements.

In some embodiments of the present disclosure, based on a period of at least one of the first reception and decoding or the second reception and decoding corresponding to a plurality of frames, at least one of the first data element or the second data element obtained from a first frame among the plurality of frames may be applied to at least one remaining frame among the plurality of frames.

In some embodiments of the present disclosure, when the first data element is divided into a plurality of sub-data elements, the first reception and decoding for the first data element may include first period-based reception and decoding for a first sub-data element among the plurality of sub-data elements and second period-based reception and decoding for a second sub-data element among the plurality of sub-data elements.

In some embodiments of the present disclosure, the dynamic 3D avatar data in a current frame may be obtained by merging first sub-avatar data based on the first sub-data element obtained based on the first period and second sub-avatar data based on the second sub-data element obtained based on the second period.

In some embodiments of the present disclosure, the dynamic 3D avatar data in a current frame may be obtained through retargeting based on information of the second data element for the first data element.

In some embodiments of the present disclosure, at least one sub-avatar data may be independently retargeted based on a combination of the first data element, or at least one sub-data element of the first data element; and the second data element, or at least one sub-data element of the second data element.

In some embodiments of the present disclosure, a post-processing process related to removal or alleviation of discontinuity between the plurality of sub-data elements may be performed.

In some embodiments of the present disclosure, the first data element may correspond to volumetric data including avatar geometry data and avatar texture data, and the second data element may correspond to avatar skeleton motion data.

In some embodiments of the present disclosure, the plurality of data elements may further include at least one of avatar audio data, avatar haptic data or avatar metadata.

The features briefly summarized above with respect to the present disclosure are just an exemplary aspect of a detailed description of the present disclosure described below, and do not limit a scope of the present disclosure.

According to the present disclosure, a method and a device for transmitting and obtaining dynamic 3-dimensional avatar data may be provided.

According to the present disclosure, a method for efficiently transmitting high-quality data by configuring dynamic 3-dimensional avatar data with a plurality of data elements and/or sub-data elements and obtaining 3-dimensional avatar data based thereon and a device therefor may be provided.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is a diagram for describing methods for transmitting or receiving dynamic 3D avatar data.

FIG. 2 is a diagram for describing an example of a method for transmitting dynamic 3D avatar data according to the present disclosure.

FIG. 3 is a diagram for describing an example of a method for obtaining dynamic 3D avatar data according to the present disclosure.

FIG. 4 is a block diagram of a transmission device according to an embodiment of the present disclosure.

FIG. 5 is a block diagram of a reception device according to an embodiment of the present disclosure.

FIG. 6 is a diagram conceptually showing a transmission and acquisition process by data element according to an embodiment of the present disclosure.

FIG. 7 represents an example of division of a data element according to the present disclosure.

FIG. 8 is a diagram showing an example of multiple sub-avatar data configurations according to the present disclosure.

FIG. 9 is a diagram showing an example of a combination of a sub-data element and sub-avatar data according to the present disclosure.

FIG. 10 is a diagram showing an example of an encoding and transmission period by sub-data element according to the present disclosure.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of “and/or” includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

Hereinafter, various embodiments of the present disclosure are described for a method for compressing or encoding and transmitting dynamic 3D avatar data on a transmission device side and decoding, obtaining and rendering dynamic 3D avatar data based on received data on a reception device side.

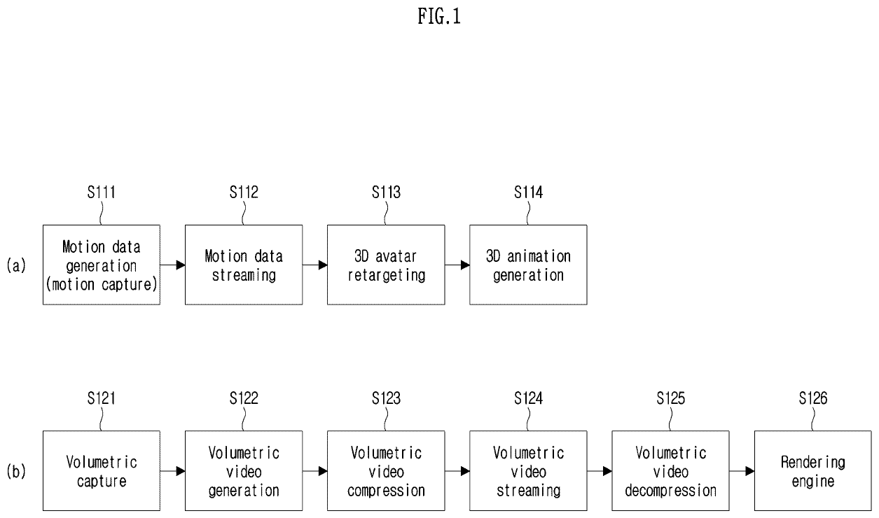

FIG. 1 is a diagram for describing methods for transmitting or receiving dynamic 3D avatar data.

An end-to-end system for transmitting or receiving dynamic 3D avatar data may be largely divided into two types.

An example of FIG. 1(a) corresponds to a 3D motion information-based retargeting method. Skeleton motion data may be generated by a motion capture device or an animation designer S111. Generated motion data may be streamed S112, and motion information may be rigged or retargeted to a static 3D character pre-generated by receiving it S113. Accordingly, a 3D animation may be generated S114. When low-capacity motion information is transmitted or received as in an example of FIG. 1(a), there is an advantage that the computational complexity of an encoding and decoding process is low and a high transmission bandwidth is not required, but there is a disadvantage that since the shape and texture information of a pre-defined 3D avatar character are fixed, discomfort due to the artificial synthesis of a 3D animation is high.

An example of FIG. 1(b) corresponds to a volumetric video compression and transmission method. By applying an existing 3D reconstruction technology such as voxel carving, actual image-based volumetric capture S121 and volumetric data may be synthesized or generated S122. High-capacity volumetric data for each frame (e.g., mesh, point cloud, voxel, etc.) may be encoded or compressed based on an existing volumetric data compression codec (e.g., V-DMC, V-PCC, G-PCC, etc. of ISO/IEC JTC 1/SC 29/WG 7) S123, and compressed volumetric video data may be streamed

S124. Received volumetric video data may be decompressed S125, and a 3D model may be rendered through a rendering engine S126. In an example of FIG. 1(b), a 3D avatar similar to the real world may be reconstructed compared to an example of FIG. 1(a), but there is a problem that a high memory and a hardware resource are needed in a data encoding and decoding process and a large transmission bandwidth is required.

For two technologies in FIG. 1, technical development and standard establishment and revision have been performed independently. For example, a method in FIG. 1(a) has been mainly utilized for a metaverse concert, a 3D movie, a 3D animation, etc. that utilize a virtual character, and a method in FIG. 1(b) has been mainly utilized for real person-based 3D sports game reconstruction and 3D idol concert reconstruction cases. Since limits and advantages of two methods are clear, detailed examples for a new dynamic 3D avatar data encoding/decoding (compression/decompression) and transmission/reception method that may fuse them in a complementary way to maintain advantages of each method and supplement limits are described below.

According to various examples of the present disclosure described below, when compressing (encoding) and transmitting avatar data including a plurality of data elements (e.g., volumetric video data and skeleton motion data), a compression rate of volumetric information may be improved and complexity may be controlled without degrading the quality of the avatar content. In other words, according to various examples of the present disclosure, in a system for encoding/decoding, transmitting/receiving, and rendering dynamic 3D avatar data including a plurality of data elements (e.g., volumetric video data and skeleton motion data), a new method and device for encoding/transmitting and receiving/decoding/obtaining dynamic 3D avatar data that may generate a 3D avatar having a higher similarity to a real-world object compared to an existing retargeting method (an example of FIG. 1(a)) and achieve a lower transmission bandwidth and a higher compression rate compared to an existing volumetric video compression and encoding method (an example of FIG. 1(b)) may be provided.

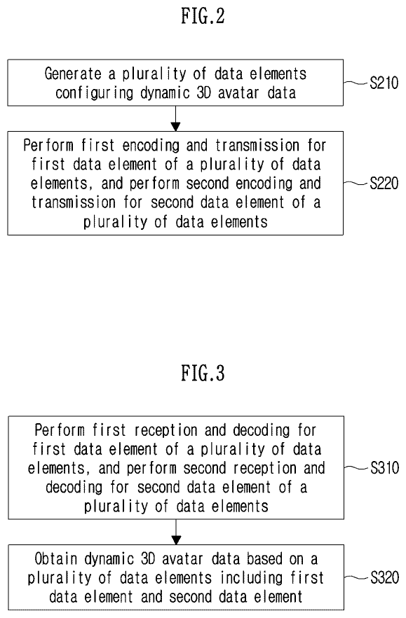

FIG. 2 is a diagram for describing an example of a method for transmitting dynamic 3D avatar data according to the present disclosure.

In S210, a transmission device may generate a plurality of data elements configuring dynamic 3D avatar data.

A plurality of data elements may include a first data element and a second data element. For example, a first data element may correspond to volumetric data including avatar geometry data and avatar texture data. For example, a second data element may correspond to avatar skeleton motion data. Additionally, a plurality of data elements may further include at least one of avatar audio data, avatar haptic data or avatar metadata. In the following description, a first data element and a second data element are not limited to a specific type of data element described above, and the following examples may be equally applied to any type of data element.

A first data element may be divided into a plurality of sub-data elements. Alternatively, a second data element may be divided into a plurality of sub-data elements. Alternatively, a first data element may be divided into a plurality of sub-data elements, and a second data element may also be divided into a plurality of sub-data elements. For example, a first data element may be divided into a plurality of sub-data elements by referring to the information of the second data element.

A combination of a first data element and a second data element, or a combination of at least one sub-data element of a first data element and a second data element, or a combination of a first data element and at least one sub-data element of a second data element, or a combination of at least one sub-data element of a first data element and at least one sub-data element of a second data element may correspond to at least one sub-avatar data.

In S220, a transmission device may perform first encoding and transmission for a first data element of a plurality of data elements, and may also perform second encoding and transmission for a second data element of a plurality of data elements.

The encoding and/or transmission of first and second data elements may be performed independently. For example, the encoding and/or transmission of first and second data elements may be performed in parallel. Alternatively, the encoding and/or transmission of first and second data elements may be performed sequentially.

When first and/or second data elements are divided into a plurality of sub-data elements, the encoding and/or transmission of a plurality of divided sub-data elements may be performed independently. For example, the encoding and/or transmission of a plurality of divided sub-data elements may be performed in parallel/sequentially.

A period of first encoding and transmission may be adaptively determined based on a characteristic of a first data element. A period of second encoding and transmission may be adaptively determined based on a characteristic of a second data element. For example, a characteristic of a data element may correspond to capacity, encoding (and/or decoding) complexity, etc.

When a first data element is divided into a plurality of sub-data elements, first encoding and transmission for a first data element may include first period-based encoding and transmission for a first sub-data element of a first data element and second period-based encoding and transmission for a second sub-data element of a first data element. Similarly, when a second data element is divided into a plurality of sub-data elements, second encoding and transmission for a second data element may include third period-based encoding and transmission for a first sub-data element of a second data element and fourth period-based encoding and transmission for a second sub-data element of a second data element.

A different period (e.g., a first period and a second period) applied to a sub-data element may be adaptively determined based on the degree of change in an attribute of a first sub-data element and a second sub-data element over time. For example, an attribute may correspond to a position, a shape, a texture, etc.

In the above-described example, a period of first encoding and transmission for a first data element may be applied independently from a period of second encoding and transmission for a second data element. A period of first encoding and transmission may be the same as or different from a period of second encoding and transmission. Similarly, a first period, a second period, a third period, a fourth period, etc. related to encoding and transmission for the sub-data elements of each of first and/or second data elements may be the same or different.

FIG. 3 is a diagram for describing an example of a method for obtaining dynamic 3D avatar data according to the present disclosure.

In S310, a reception device may perform first reception and decoding for a first data element of a plurality of data elements, and may perform second reception and decoding for a second data element of a plurality of data elements. Accordingly, a first data element and a second data element may be acquired.

The reception and/or decoding of first and second data elements may be performed independently. For example, the reception and/or decoding of first and second data elements may be performed in parallel. Alternatively, the reception and/or decoding of first and second data elements may be performed sequentially.

When first and/or second data elements are divided into a plurality of sub-data elements, the reception and/or decoding of a plurality of divided sub-data elements may be performed independently. For example, the reception and/or decoding of a plurality of divided sub-data elements may be performed in parallel/sequentially.

Based on a period of first reception and decoding corresponding to a plurality of frames, a first data element obtained from a first frame of a plurality of frames may be applied to at least one remaining frame of a plurality of frames. Additionally or alternatively, based on a period of second reception and decoding corresponding to a plurality of frames, a second data element obtained from a first frame of a plurality of frames may be applied to at least one remaining frame of a plurality of frames.

When a first data element is divided into a plurality of sub-data elements, first reception and decoding for a first data element may include first period-based reception and decoding for a first sub-data element of a first data element and second period-based reception and decoding for a second sub-data element of a first data element. Similarly, when a second data element is divided into a plurality of sub-data elements, second reception and decoding for a second data element may include third period-based reception and decoding for a first sub-data element of a second data element and fourth period-based reception and decoding for a second sub-data element of a second data element.

In the above-described example, a period of first reception and decoding for a first data element may be applied independently from a period of second reception and decoding for a second data element. A period of first reception and decoding may be the same as or different from a period of second reception and decoding. Similarly, a first period, a second period, a third period, a fourth period, etc. related to reception and decoding for sub-data elements of each of first and/or second data elements may be the same or different.

In S320, a reception device may obtain dynamic 3D avatar data based on a plurality of data elements including a first data element and a second data element.

For example, a first data element may correspond to volumetric data including avatar geometry data and avatar texture data. For example, a second data element may correspond to avatar skeleton motion data. Additionally, a plurality of data elements may further include at least one of avatar audio data, avatar haptic data or avatar metadata. In the following description, a first data element and a second data element are not limited to a specific type of data element described above, and the following examples may be equally applied to any type of data element.

For example, the dynamic 3D avatar data in a current frame may be obtained through retargeting based on information of a second data element (e.g., skeleton motion data) for a first data element (e.g., volumetric data).

At least one sub-avatar data may be independently retargeted through a combination of a first data element and a second data element, or a combination of at least one sub-data element of a first data element and a second data element, or a combination of a first data element and at least one sub-data element of a second data element, or a combination of at least one sub-data element of a first data element and at least one sub-data element of a second data element. The dynamic 3D avatar data in a current frame may be obtained by merging sub-avatar data.

In some examples, a post-processing process related to removing or alleviating a discontinuity between a plurality of sub-data elements may be performed.

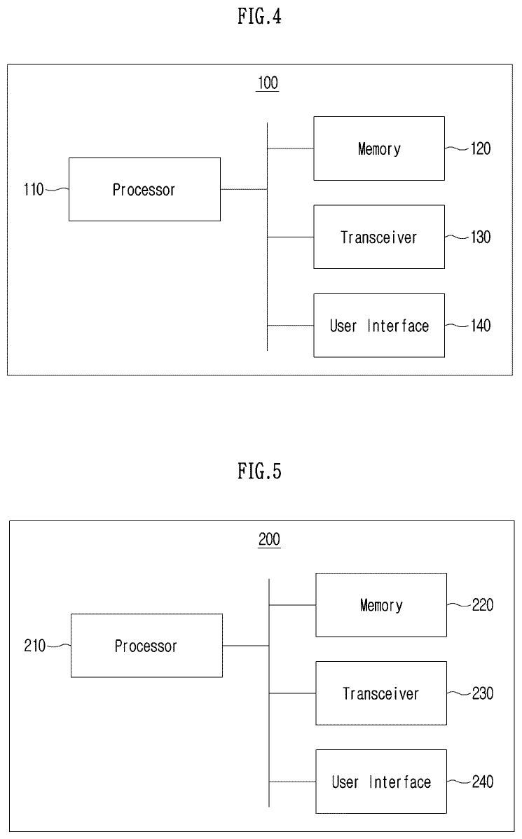

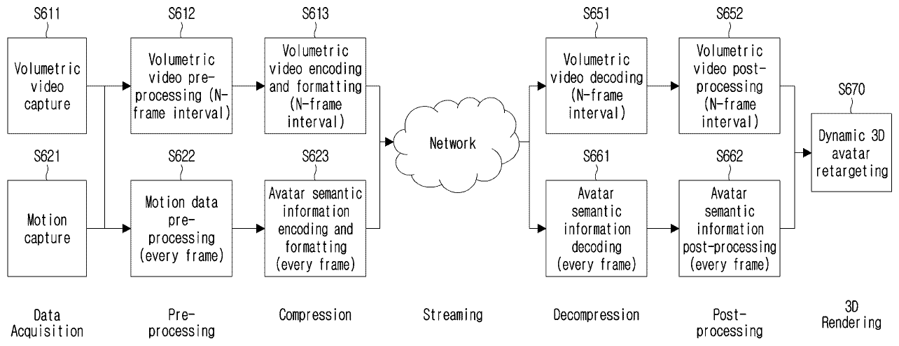

FIG. 4 is a block diagram of a transmission device according to an embodiment of the present disclosure.

A device 100 may include at least one processor 110, at least one memory 120, at least one transceiver 130, at least one user interface 140, etc. A memory 120 may be included in a processor 110 or may be configured separately. A memory 120 may store an instruction that makes a device 100 perform an operation when executed by a processor 110. A transceiver 130 may transmit and/or receive a signal, data, etc. exchanged by a device 100 with another entity. A user interface 140 may receive a user's input for a device 100 or provide the output of a device 100 to a user. Among the components of a device 100, components other than a processor 110 and a memory 120 may not be included in some cases, and other components not shown in FIG. 4 may be included in a device 100.

A processor 110 may be configured to make the above-described device 100 perform a method for transmitting dynamic 3D avatar data according to various examples of the present disclosure. Although not shown in FIG. 4, a processor 110 may be configured as a set of modules that perform each function of a data element (and sub-data element) generation unit, a data element (and sub-data element) encoding unit, a data element (and sub-data element) transmission unit, etc. A module may be configured in a form of hardware and/or software. For example, a processor 110 may be configured to generate a plurality of data elements (and sub-data elements) configuring dynamic 3D avatar data and perform encoding of each of a plurality of data elements (or sub-data elements) and transmission through a transceiver 130.

FIG. 5 is a block diagram of a reception device according to an embodiment of the present disclosure.

A device 200 may include at least one processor 210, at least one memory 220, at least one transceiver 230, at least one user interface 240, etc. A memory 220 may be included in a processor 210 or may be configured separately. A memory 220 may store an instruction that makes a device 200 perform an operation when executed by a processor 210. A transceiver 230 may transmit and/or receive a signal, data, etc. exchanged by a device 200 with another entity. A user interface 240 may receive a user's input for a device 200 or provide the output of a device 200 to a user. Among the components of a device 200, components other than a processor 210 and a memory 220 may not be included in some cases, and other components not shown in FIG. 5 may be included in a device 200.

A processor 210 may be configured to make the above-described device 200 perform a method for obtaining dynamic 3D avatar data according to various examples of the present disclosure. Although not shown in FIG. 5, a processor 210 may be configured as a set of modules that perform each function of a data element (and sub-data element) reception unit, a data element (and sub-data element) decoding unit, a data element (and sub-data element) acquisition unit, a data element (and sub-data element)-based dynamic 3D avatar data acquisition unit, etc. A module may be configured in a form of hardware and/or software. For example, a processor 210 may be configured to obtain a plurality of data elements (and sub-data elements) through reception and encoding of each of a plurality of data elements (or sub-data elements) through a transceiver 230 and obtain dynamic 3D avatar data based on a plurality of obtained data elements (and sub-data elements). Furthermore, a processor 210 may be configured to render a dynamic 3D avatar based on obtained dynamic 3D avatar data.

Hereinafter, a detailed operation and characteristic of a transmission device are described by referring to an example of FIG. 2 and FIG. 4 and a detailed operation and characteristic of a reception device are described by referring to an example of FIG. 3 and FIG. 5.

First, an expression method for each data element configuring dynamic 3D avatar data, and encoding and transmission are described.

As described above, dynamic 3D avatar data according to the present disclosure may include the following exemplary data elements.

A first data element may include avatar geometry data and avatar texture data. Avatar geometry data and avatar texture data may be integrated and referred to as volumetric data. Avatar geometry data may include two-dimensional or three-dimensional geometric information (e.g., a mesh, a point cloud, a voxel, etc.) of a point and a face configuring an avatar. Avatar texture data may include color information (e.g., a texture map) of a point, a voxel and a face configuring an avatar.

A second data element may include avatar skeleton motion data. Skeleton motion data may include two-dimensional or three-dimensional motion information of skeleton (e.g., joint position and rotation information).

A third data element may include avatar audio data, a fourth data element may include avatar haptic data and a fifth data element may include avatar metadata.

These data elements are exemplary, and do not list all possible examples, and other examples may be added, and some/all of the examples described above may be replaced with other examples.

A data element that configures avatar data may be divided according to a characteristic. A result of dividing a data element may be referred to as a sub-data element. In addition, a different encoding and transmission method may be applied per data element (or sub-data element). For example, each of at least one data element may be configured in a form divided by a method for dividing an avatar. For example, when an avatar corresponds to a human shape, a data element may be divided and expressed per body part and encoded and transmitted.

Hereinafter, selection/control of a compression (or encoding) and transmission period for each data element configuring dynamic 3D avatar data is described.

For example, a compression and transmission period may be set equally or differently for different data elements configuring 3D avatar data.

This compression and transmission period may be adaptively selected or calculated by considering capacity, encoding complexity, etc. for each data element. In addition, a compression and transmission period for each data element may be signaled from a transmission device to a reception device as meta information.

As an example, geometric information and texture information of a human avatar in a form of mesh data may be transmitted every 30 frames and skeleton motion information may be transmitted every frame (i.e., every 1 frame).

As another example, skeleton motion information of avatar data may be transmitted every frame, and volumetric data (i.e., data including geometry data and texture data) may be transmitted at an interval of tens of frames. In this case, in frame(s) where volumetric data is not transmitted, the avatar data of a current frame may be acquired by applying a retargeting technology based on the most recently transmitted volumetric data and skeleton motion data transmitted from a current frame.

As another example, when the shape and texture information of avatar data are not changed during the entire frame sequence section, only a first frame may transmit the volumetric data of avatar data and afterwards, the remaining frames may transmit only skeleton motion data of avatar data. Accordingly, a receiving end may obtain the avatar data of a current frame and render a dynamic 3D avatar by applying a retargeting technology based on volumetric data transmitted from a first frame and skeleton motion data of a current frame.

FIG. 6 is a diagram conceptually showing a transmission and acquisition process by data element according to an embodiment of the present disclosure.

The entire process may include data acquisition, preprocessing, compression, streaming, decompression, postprocessing and 3D rendering.

A data acquisition process in a transmission device may include volumetric video capture in S611 and motion capture in S621. Based on acquired data, preprocessing (e.g., data division) for a volumetric video in S612 may be performed at an interval of N (e.g., N is an integer greater than or equal to 2) frames, and preprocessing (e.g., motion in-betweening) for motion data in S622 may be performed every frame. In a compression process for preprocessed data, encoding and formatting for a volumetric video in S613 may be performed at an interval of N frames, and encoding and formatting for avatar semantic information in S623 may be performed every frame. A variety of avatar data compressed in this way may be streamed to a reception device through a network. This encoding and transmission period is just an example, and as described above, for a period of encoding and transmission for a first data element (e.g., a volumetric video), a value of at least 1 frame may be applied, and for a period of encoding and transmission for a second data element (e.g., avatar semantic information), a value of at least 1 frame may be applied, and a period of encoding and transmission for a different data element may be the same or different.

In a decompression process in a reception device, volumetric video decoding in S651 may be performed at an interval of N frames, and avatar semantic information decoding in S661 may be performed every frame. In a post-processing process, volumetric video post-processing (e.g., data composition) in S652 may be performed at an interval of N frames, and motion data post-processing (e.g., motion in-betweening) in S662 may be performed every frame. In a 3D rendering process based on a plurality of data elements obtained in this way, dynamic 3D avatar retargeting may be performed every frame in S670. This reception and decoding period is just an example, and as described above, for a period of reception and decoding for a first data element (e.g., a volumetric video), a value of at least 1 frame may be applied, and for a period of reception and decoding for a second data element (e.g., avatar semantic information), a value of at least 1 frame may be applied, and a period of reception and decoding for a different data element may be the same or different.

Hereinafter, examples of the present disclosure for dividing each data element into sub-data elements are described.

For example, among the avatar data elements, mesh-shaped avatar geometry data may be subdivided into sub-mesh-shaped geometry data. For example, a term called sub-mesh corresponds to a unit that corresponds to a detailed region where mesh data is divided into multiple spatial regions and guarantees independent encoding, decoding, transmission and reception for each divided region, and may include a concept of sub-mesh defined in the Video based Dynamic Mesh Coding (V-DMC) technology that is currently being standardized in ISO/IEC JTC 1/SC 29/WG 7.

For example, for a human avatar, a data element may be divided based on a body part.

As another example, the density of a vertex that configures volumetric data may be analyzed and a data element may be divided based on a boundary point where the density of a vertex changes rapidly. As a unit for dividing a data element, a vertex is just an example, and data element division may be performed in a unit of a face, a voxel or a splat that are another 3D representation unit or in a unit of a vertex group, a face group, a super-voxel, etc. that are a group of 3D representation units. In examples below, it is described by using a vertex as a representative example for clarity of a description, but examples of the present disclosure may be equally applied to another unit (e.g., a face, a voxel, a splat, etc.)/unit group (e.g., a vertex group, a face group, a super-voxel, etc.).

The division of a specific data element of avatar data may be performed by referring to information of another data element.

For example, a specific data element may be divided by body part (e.g., divided into hands, feet, arms, legs and torso) to generate a sub-data element and in this division process, information of another data element including body part information may be referred to.

As a specific example, volumetric data may be divided into a plurality of sub-volumetric data by referring to skeleton motion information. For example, based on joint information configuring skeleton motion information, data corresponding to the entire body of an avatar (e.g., volumetric data) may be divided into a plurality of sub-body parts (e.g., sub-volumetric data).

Each divided body part may be independently encoded/decoded and transmitted/received and may be processed in parallel to enable simultaneous encoding/decoding and transmission/reception.

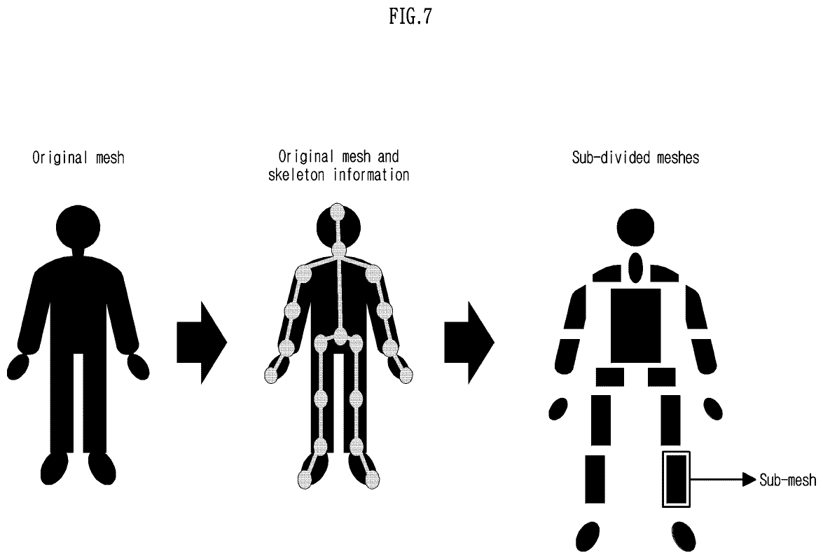

FIG. 7 represents an example of division of a data element according to the present disclosure.

When an avatar is mesh data, a mesh region positioned between two connected joints may be divided into one sub-mesh. Each sub-mesh may be independently encoded/decoded and transmitted/received.

In a human avatar, mesh-shaped volumetric data may be divided into sub-volumetric data corresponding to a body part such as a face, a head, a neck, an upper body, arms (specifically, a top-left arm, a bottom-left arm, a top-right arm, a bottom-right arm), legs (specifically, a top-left leg, a bottom-left leg, a top-right leg, a bottom-right leg), hands (a left hand, a right hand), feet (a left foot, a right foot), etc. based on joint information of skeleton. Each sub-volumetric data may be independently encoded/decoded and transmitted/received in a form of a sub-mesh. A sub-mesh may correspond to a sub-mesh in V-DMC as described above.

Skeleton motion data may include position and rotation information of multiple 3D joints.

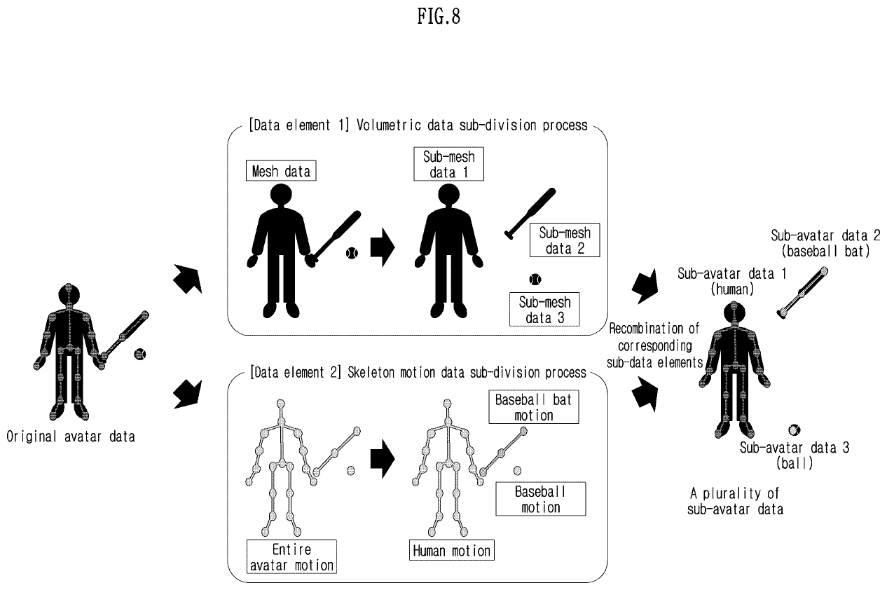

FIG. 8 is a diagram showing an example of multiple sub-avatar data configurations according to the present disclosure.

One sub-avatar data may be configured or obtained by matching sub-data elements that are matched among the different data elements configuring avatar data and recombining sub-data elements.

A different type of sub-data element associated to each sub-data element may be mutually matched. And one sub-avatar data may be configured/obtained by combining each corresponding sub-data element.

For example, volumetric data (e.g., human-shaped mesh data) and skeleton motion data (e.g., full-body motion data) that configure avatar data (e.g., a human avatar) may be divided into sub-volumetric data (e.g., hand-shaped sub-mesh data) and sub-skeleton motion data (e.g., hand motion data), respectively. In this case, corresponding sub-volumetric data (e.g., hand-shaped sub-mesh data) and sub-skeleton motion data (e.g., hand motion data) may be correlated and combined to generate sub-avatar data (e.g., hands of a human avatar).

Referring to FIG. 8, original avatar data may include mesh data (or volumetric data) and skeleton motion data.

One mesh data may be divided into a plurality of sub-mesh data. For example, volumetric data for a person holding a baseball bat and a baseball ball may be divided into sub-mesh data 1 including volumetric data for the human body, sub-mesh data 2 including volumetric data for a baseball bat and sub-mesh data 3 including volumetric data for a baseball ball.

Similarly, one skeleton motion data may be divided into a plurality of sub-motion data. For example, skeleton motion data for a person, a baseball bat and a baseball ball may be divided into sub-motion data 1 for a motion of a person's body, sub-motion data 2 for a motion of a baseball bat and sub-motion data 3 for a motion of a baseball ball.

Accordingly, sub-avatar data 1 for a person may be configured by combining sub-mesh data 1 and sub-motion data 1. Avatar data 2 for a baseball bat may be configured by combining sub-mesh data 1 and sub-motion data 2. Sub-avatar data 3 for a baseball ball may be configured by combining sub-mesh data 3 and sub-motion data 3. In addition, the entire avatar data may be configured by combining a plurality of these sub-avatar data 1, 2 and 3.

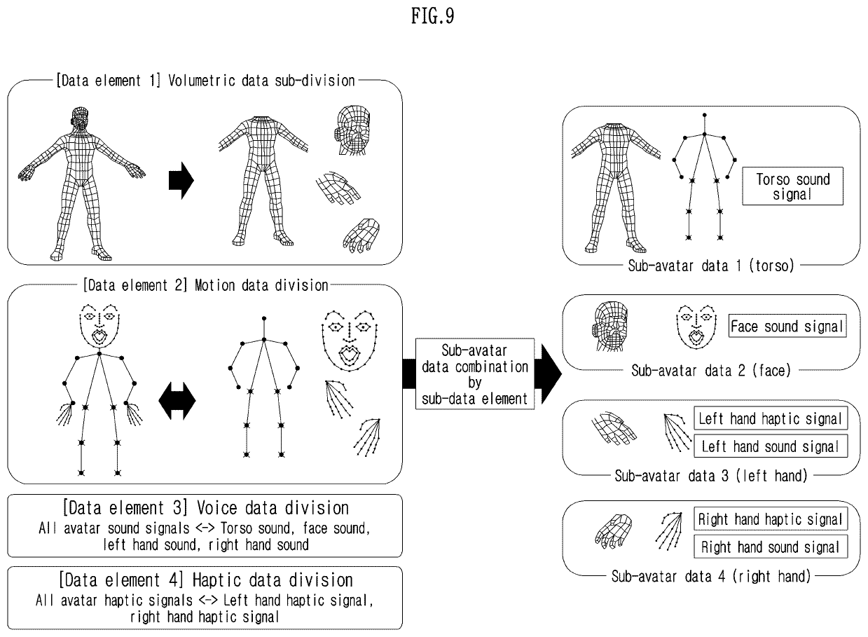

FIG. 9 is a diagram showing an example of a combination of a sub-data element and sub-avatar data according to the present disclosure.

Even when a sub-division process for each data element of avatar data is different or a specific data element does not require a sub-division process (e.g., when a target data element is a combination of pre-divided data), a corresponding sub-data element may be found, connected and reconstructed into new sub-avatar data.

For example, it is assumed that volumetric data (e.g., mesh data representing the entire body of an avatar) is divided to generate sub-volumetric data (e.g., sub-mesh data representing the left hand of an avatar). In this case, a division structure may be associated with pre-defined semantic data of an avatar (e.g., motion information of the left hand, sound information of the left hand, physical characteristic information of the left hand, etc.) and associated sub-data elements may be combined to reconstruct new sub-avatar data.

Referring to FIG. 9, volumetric data corresponding to data element 1 may be divided into four sub-volumetric data corresponding to the torso, the face, the left hand and the right hand. Motion data corresponding to data element 2 may be divided into four sub-motion data corresponding to the torso, the face, the left hand and the right hand. Audio (e.g., voice, sound, etc.) data corresponding to data element 3 may be divided into four voice/sound data corresponding to the torso, the face, the left hand and the right hand. Haptic data corresponding to data element 4 may be divided into four sub-haptic data corresponding to the torso, the face, the left hand and the right hand. Some of the sub-data elements may not be generated because they do not have information. For example, sub-haptic data may not be generated for the torso and the face. Accordingly, a plurality of sub-avatar data may be configured by combining mutually corresponding sub-data elements.

Independent encoding/decoding, transmission/reception and rendering may be performed for each sub-avatar data generated in this way. For example, first sub-avatar data which is composed of first sub-volumetric data, first sub-skeleton motion data, first sub-audio data, first sub-haptic data, first sub-meta data, etc. may be encoded/decoded, transmitted/received and rendered independently from second sub-avatar data which is composed of second sub-volumetric data, second sub-skeleton motion data, second sub-audio data, second sub-haptic data, second sub-meta data, etc.

When sub-avatar data includes skeleton motion data, retargeting for each sub-avatar data may be performed independently. For example, in a reception device that receives first sub-avatar data including first sub-volumetric data and first sub-skeleton motion data, retargeting may be applied by reflecting first sub-skeleton motion data to first sub-volumetric data. Similarly, in a reception device that receives second sub-avatar data including second sub-volumetric data and second sub-skeleton motion data, retargeting may be applied by reflecting second sub-skeleton motion data to second sub-volumetric data.

A period for encoding and/or transmission may be adaptively applied for each sub-volumetric data that configures the volumetric data of an avatar.

For example, based on one avatar body being divided into multiple body parts, one volumetric data may be divided into multiple sub-volumetric data. Sub-volumetric data corresponding to each body part may correspond to an encoding unit that may be independently encoded and transmitted. Similarly, each sub-volumetric data may correspond to a decoding unit that may be independently received and decoded.

For example, encoding and transmission periods may be configured differently for each sub-volumetric data. The present disclosure does not exclude a case in which encoding and transmission periods for some/all sub-volumetric data are the same.

For example, encoding and transmission periods may be adaptively selected or calculated by considering a spatial position, a shape change, etc. according to the flow of time for each sub-volumetric data corresponding to a specific body part of an avatar.

As a specific example, for mesh-shaped avatar data, a sub-mesh (e.g., legs, arms, torso, etc.) whose shape and texture do not change over time (or whose degree of attribute change over time is relatively low) may be encoded and transmitted in a unit of 300 frames. On the other hand, a sub-mesh (e.g., the face, hands, feet, hair, etc.) whose shape and texture change over time (or whose degree of attribute change over time is relatively high) may be encoded and transmitted in a unit of 1 frame.

This sub-mesh may correspond to a division unit available for independent decoding defined in the V-DMC codec as described above. For example, in a next-generation dynamic mesh compression codec or a next-generation avatar compression codec including the V-DMC codec, a syntax representing compression and transmission periods for each sub-volumetric data may be explicitly/implicitly signaled from a transmission device to a reception device or may be included in metadata and transmitted. For example, when a mesh is divided in a sub-mesh unit and compressed through the V-DMC codec, a frame rate syntax representing compression and transmission periods for each sub-mesh may be explicitly/implicitly signaled or may be transmitted as a V3C SEI message.

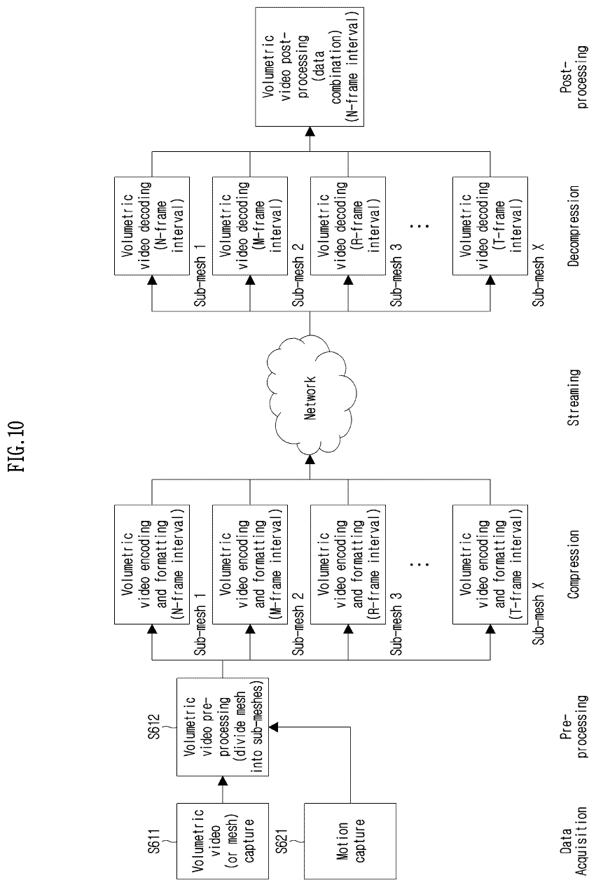

FIG. 10 is a diagram showing an example of an encoding and transmission period by sub-data element according to the present disclosure.

An example of FIG. 10 mainly describes a case in which one volumetric (or mesh) data is divided into a plurality of sub-volumetric (or sub-mesh) data, but it may also be similarly applied to a case in which another data element (e.g., skeleton motion data, audio data, haptic data, metadata, etc.) is divided into a plurality of sub-data elements.

Since S611 and S621 in FIG. 10 are the same as those described by referring to FIG. 6, an overlapping description is omitted.

In a preprocessing process for dividing a volumetric (mesh) data element in S612 into sub-volumetric (sub-mesh) data elements, a skeleton motion data element which is another data element may be referred to.

It is assumed that one mesh is divided into X sub-meshes. Sub-mesh 1 may be encoded and formatted at an interval of N frames, sub-mesh 2 may be encoded and formatted at an interval of M frames, sub-mesh 3 may be encoded and formatted at an interval of R frames, . . . , sub-mesh X may be encoded and formatted at an interval of T frames. Here, a value of N, M, R, . . . , T may be different from each other or some/all may be the same. For X sub-volumetric data streamed through a network, volumetric video decoding may be performed, respectively. For example, sub-mesh 1 may be decoded at an interval of N frames, sub-mesh 2 may be decoded at an interval of M frames, sub-mesh 3 may be decoded at an interval of R frames, . . . , sub-mesh X may be decoded at an interval of T frames. Accordingly, a post-processing process for combining X decoded volumetric video data may be performed. For example, if it is assumed that N is the smallest value among N, M, R, . . . , T, a post-processing process may be performed every N frames. Here, for other sub-mesh(s) where a new value is not received/decoded, a combination of sub-meshes may be performed based on the most recently received data.

In other words, even when a period during which sub-volumetric data is reconstructed is different for each divided body part, it may be merged and retargeted based on the skeleton motion information of a current frame and sub-volumetric data transmitted and reconstructed up to now.

For example, when a plurality of sub-meshes are transmitted at a different period, a receiving end may store the most recently reconstructed sub-mesh. And, the sub-mesh data of a current frame may be reconstructed by moving, rotating and transforming the latest reconstructed sub-mesh based on the skeleton motion information of a current frame and each reconstructed sub-mesh may be re-merged into one mesh.

As an additional example, for a dynamic avatar where the body is fixed and only a face moves, the mesh-shaped avatar of a current frame may be reconstructed by replacing only a sub-mesh of a face region in a mesh-shaped avatar reconstructed in a previous frame.

A discontinuity of a boundary between each sub-volumetric data with different compression (or encoding) and transmission periods may be removed as follows.

In order to remove a hole/a crack created by a discontinuity of geometric information at a boundary between spatially adjacent sub-volumetric data, a post-processing process for readjusting a position of 3D vertexes positioned at a boundary of sub-volumetric data may be included. It may be called a hole/crack removal technique in a boundary region between sub-volumetric data. As a unit for removing a discontinuity of geometric information, a vertex is just an example, and discontinuity/hole/crack removal may be performed in a unit of a face, a voxel or a splat that are another 3D representation unit or in a unit of a vertex group, a face group, a super-voxel, etc. that are a group of 3D representation units. In examples below, it is described by using a vertex as a representative example for clarity of a description, but examples of the present disclosure may be equally applied to another unit (e.g., a face, a voxel, a splat, etc.)/unit group (e.g., a vertex group, a face group, a super-voxel, etc.).

In addition, in order to alleviate a discontinuity of texture information at a boundary between sub-volumetric data, a color value or a brightness value of vertexes positioned at a boundary region between body parts may be readjusted or a texture map pixel value of a corresponding region may be readjusted. It may be called a texture smoothing technique in a boundary region between sub-volumetric data.

As a specific example, when a left-hand sub-mesh transmitted per frame is connected to a left-arm sub-mesh transmitted at an interval of 30 frames, a position of vertexes positioned at a sub-mesh boundary may be readjusted to connect vertexes corresponding to a boundary of two sub-meshes in order to remove (or fill) a hole/a crack created in a boundary region between two sub-meshes.

As an additional example, by utilizing a morphing technique that may distort and transform a shape of mesh data, a shape of a triangle configuring a sub-mesh may be distorted to connect triangles between sub-mesh boundaries.

Also for skeleton motion data, a more natural motion may be rendered by estimating unreceived/non-existent data. For example, avatar skeleton motion data for all frames may be generated based on avatar skeleton motion data extracted from some frames. It may be called a 3D skeleton motion correction and interpolation technique.

When avatar skeleton motion information with high accuracy/precision is generated for some frames (e.g., a key frame), avatar skeleton motion information for a frame other than a key frame may be estimated by applying a motion interpolation technique such as an in-betweening technique. For example, a key frame period may be automatically calculated by considering a network environment or hardware specifications, etc. or may be designated in advance by a user.

As a specific example, avatar skeleton motion data may be generated based on a pose estimation technique for each key frame that exists at a period of 30 frames. And, avatar skeleton motion data may also be estimated/generated for all remaining frames between key frames based on an in-betweening technique. Skeleton motion data estimated for all frames may be integrated and transformed to an animation file format such as BVH, FBX, etc. or may be transmitted to a viewer terminal or a 3D rendering engine.

A compression codec of a specific data element may also refer to information of another data element. For example, skeletal motion data may be referred to in a volumetric data compression codec. As a more specific example, skeleton motion information may be referred to in an inter prediction process of a volumetric data compression codec (e.g., V-DMC, V-PCC, G-PCC, etc. of ISO/IEC JTC 1/SC 29/WG 7).

In addition, the motion vector information of all 3D vertexes configuring volumetric data (e.g., a mesh, a point cloud, a voxel, etc.) may be inferred based on the skeleton motion information of an avatar. As a unit for inferring/predicting motion vector information, a vertex is just an example, and motion vector information may be inferred in a unit of a face, a voxel or a splat that are another 3D representation unit or in a unit of a vertex group, a face group, a super-voxel, etc. that are a group of 3D representation units. In examples below, it is described by using a vertex as a representative example for clarity of a description, but examples of the present disclosure may be equally applied to another unit (e.g., a face, a voxel, a splat, etc.)/unit group (e.g., a vertex group, a face group, a super-voxel, etc.).

For example, in a motion vector estimation process of a 3D vertex in the inter-frame coding of a volumetric video compression codec, a 3D vertex motion vector of volumetric data may be predicted based on the skeleton motion data of an avatar.

In addition, based on the motion and rotation information of two connected joints, a motion vector value of all vertexes of sub-volumetric data positioned between two joints may be estimated.

For example, skeleton motion data may include position and rotation information on multiple joints. Only a differential signal between the motion vector information of a mesh vertex predicted based on the skeleton motion data of an avatar and the motion vector information of an actual mesh vertex may be provided from a transmission device to a reception device.

As an additional example, when a differential size between a motion vector of a mesh vertex predicted based on skeleton motion data and a motion vector of an actual mesh vertex is less than or equal to a threshold value during an encoding process, the motion information of a predicted mesh vertex may be used by referring to skeleton motion data during a decoding process of a mesh codec without signaling the motion vector information of a mesh vertex. It may correspond to a skip mode of motion vector coding.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of hardware and software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A method for transmitting dynamic 3-dimensional (3D) avatar data, the method comprising:
generating a plurality of data elements configuring the dynamic 3D avatar data;
performing a first encoding and transmission for a first data element of the plurality of data elements; and
performing a second encoding and transmission for a second data element of the plurality of data elements,
wherein each of at least one of the first data element or the second data element is divided into a plurality of sub-data elements.

2. The method of claim 1, wherein:
a period of the first encoding and transmission and a period of the second encoding and transmission are adaptively determined based on a characteristic of the first data element and the second data element, respectively.

3. The method of claim 1, wherein:
when the first data element is divided into the plurality of sub-data elements, the first encoding and transmission for the first data element includes:
a first period-based encoding and transmission for a first sub-data element among the plurality of sub-data elements, and
a second period-based encoding and transmission for a second sub-data element among the plurality of sub-data elements.

4. The method of claim 3, wherein:
the first period and the second period are adaptively determined based on a degree of a change in an attribute of the first sub-data element and the second sub-data element over time, respectively.

5. The method of claim 1, wherein:
the first data element is divided into the plurality of sub-data elements by referring to information of the second data element.

6. The method of claim 1, wherein:
an encoding and a transmission of the plurality of sub-data elements are performed independently or in parallel.

7. The method of claim 1, wherein:
based on a combination of the first data element, or at least one sub-data element of the first data element; and
the second data element, or at least one sub-data element of the second data element,
at least one sub-avatar data is configured.

8. The method of claim 1, wherein:
the first data element corresponds to volumetric data including avatar geometry data and avatar texture data,
the second data element corresponds to avatar skeleton motion data.

9. The method of claim 8, wherein:
the plurality of data elements further include at least one of avatar audio data, avatar haptic data, or avatar metadata.

10. A method for obtaining dynamic 3-dimensional (3D) avatar data, the method comprising:
obtaining a first data element based on a first reception and decoding for an encoded first data element of a plurality of data elements;
obtaining a second data element based on a second reception and decoding for an encoded second data element of the plurality of data elements; and
obtaining the dynamic 3D avatar data based on the plurality of data elements including the first data element and the second data element,
wherein each of at least one of the first data element or the second data element is divided into a plurality of sub-data elements.

11. The method of claim 10, wherein:
based on a period of at least one of the first reception and decoding or the second reception and decoding corresponding to a plurality of frames,
at least one of the first data element or the second data element obtained from a first frame among the plurality of frames is applied to at least one remaining frame among the plurality of frames.

12. The method of claim 10, wherein:
when the first data element is divided into the plurality of sub-data elements, the first reception and decoding for the first data element includes:
a first period-based reception and decoding for a first sub-data element among the plurality of sub-data elements, and
a second period-based reception and decoding for a second sub-data element among the plurality of sub-data elements.

13. The method of claim 12, wherein:
through a merger of first sub-avatar data based on the first sub-data element obtained based on the first period, and second sub-avatar data based on the second sub-data element obtained based on the second period, the dynamic 3D avatar data in a current frame is obtained.

14. The method of claim 10, wherein:
through a retargeting based on information of the second data element for the first data element, the dynamic 3D avatar data in a current frame is obtained.

15. The method of claim 10, wherein:
based on a combination of the first data element, or at least one sub-data element of the first data element; and
the second data element, or at least one sub-data element of the second data element,
at least one sub-avatar data is independently retargeted.

16. The method of claim 10, wherein:
a post-processing process related to a removal or an alleviation of a discontinuity between the plurality of sub-data elements is performed.

17. The method of claim 10, wherein:
the first data element corresponds to volumetric data including avatar geometry data and avatar texture data,
the second data element corresponds to avatar skeleton motion data.

18. The method of claim 17, wherein:
the plurality of data elements further include at least one of avatar audio data, avatar haptic data, or avatar metadata.

19. A device for transmitting dynamic 3-dimensional (3D) avatar data, the device comprising:
at least one processor; and
at least one memory operably connected to the at least one processor, and storing an instruction for making the device to perform an operation when being executed by the at least one processor,
wherein the operation includes:
generating a plurality of data elements configuring the dynamic 3D avatar data;
performing a first encoding and transmission for a first data element of the plurality of data elements; and
performing a second encoding and transmission for a second data element of the plurality of data elements,
wherein each of at least one of the first data element or the second data element is divided into a plurality of sub-data elements.

20. A device for obtaining dynamic 3-dimensional (3D) avatar data, the device comprising:
at least one processor; and
at least one memory operably connected to the at least one processor, and storing an instruction for making the device to perform an operation when executed by the at least one processor,
wherein the operation includes:
obtaining a first data element based on a first reception and decoding for an encoded first data element of a plurality of data elements;
obtaining a second data element based on a second reception and decoding for an encoded second data element of the plurality of data elements; and
obtaining the dynamic 3D avatar data based on the plurality of data elements including the first data element and the second data element,
wherein each of at least one of the first data element or the second data element is divided into a plurality of sub-data elements.
